(19) United States
(12) Patent Application Publication
(10) Pub. No.: US 2020/0132158 A1
(43) Pub. Date: Apr. 30, 2020

(54) POWER TRANSMISSION DEVICE FOR A VEHICLE

(71) Applicant: EXEDY Corporation, Osaka (JP)

(72) Inventor: Keiichi YASUDA, Osaka (JP)

(73) Assignee: Exedy Corporation

(21) Appl. No.: 16/585,338

(22) Filed: Sep. 27, 2019

(30) Foreign Application Priority Data
Oct. 26, 2018 (JP) 2018-202290

(51) Int. Cl. F16F 15/10; F16H 61/10

(52) U.S. Cl. CPC F16F 15/10; F16H 2045/0231; F16H 61/10

(57) ABSTRACT

A power transmission device is disclosed. The device includes a first rotating member, a second rotating member rotating relative to the first rotating member, and a torque transmission portion. The torque transmission portion is provided on the first rotating member and transmits torque from one of the first and second rotating members to the other via a hydraulic fluid. The torque transmission portion includes an oil chamber portion filled with the hydraulic fluid, a first piston pressing the second rotating member, a second piston retaining the hydraulic fluid in the oil chamber portion with the first piston, and an elastic portion elastically holding the second piston. The first piston receives pressure of the hydraulic fluid on a first pressure receiving area. The second piston receives pressure of the hydraulic fluid on a second pressure receiving area. The first pressure receiving area is smaller than the second pressure receiving area.

### CROSS-REFERENCE TO RELATED APPLICATIONS

This application claims priority to Japanese Patent Application No. 2018-202290, filed Oct. 26, 2018. The contents of that application are incorporated by reference herein in their entirety.

### TECHNICAL FIELD

The present invention relates to a power transmission device for a vehicle.

### BACKGROUND ART

In a conventional power transmission device for a vehicle, for example, a damper device, an input rotating member and an output rotating member are connected by a coil spring (torque transmission portion). In this case, when torque is input to the input rotating member, the coil spring is compressed between the input rotating member and the output rotating member. Further, when torque fluctuation is input to the input rotating member, the elastic member expands and contracts between the input rotating member and the output rotating member.

Generally, in a damper device, when the frequency of torque fluctuation, which is input from the engine to the damper device, approaches the natural frequency of the damper device, the damper device can resonate. This resonance phenomenon occurs when the engine speed approaches a predetermined speed (resonance speed). See JP-A-10-196764. For this reason, in the conventional damper device, the resonance rotational speed is often set to the low rotational speed side by reducing the spring rigidity of the damper device.

However, when the vehicle type or the engine type is changed, the resonance rotational speed changes. Therefore, in the conventional damper device, it is necessary to adjust the spring rigidity each time. For this reason, development of the damper apparatus which can easily set a spring is desired.

Further, in the conventional damper device, if it is attempted to reduce the spring stiffness, it is necessary to ensure the spring strength against the repeated stress acting on the spring, so that the spring diameter can be increased. On the other hand, if the spring rigidity is reduced without increasing the spring diameter, the spring length can be increased. As described above, in the conventional damper device, the size of the damper device can increase by enlargement of the spring diameter.

Also, the larger the damper device is, the greater the weight of the damper device is. Also, the larger the spring diameter is, the more difficult it is to arrange the spring in the damper device. Further, the larger the damper device is, the larger the range in which the spring slides with the peripheral member is. Thereby, the hysteresis torque can increase. For example, when the hysteresis torque increases, the equivalent rigidity of the damper device increases. As a result, the damping performance can be reduced.

The present invention has been made in view of the above problems, and an object of the present invention is to provide a power transmission device for a vehicle that can easily reduce the rigidity. Moreover, the objective of this invention is to achieve size reduction and weight reduction of the power transmission device for vehicles. Moreover, the objective of this invention is to improve the flexibility of the layout of a torque transmission portion in the power transmission device for vehicles.

### BRIEF SUMMARY

A power transmission device for a vehicle according to one aspect of the present invention comprises a first rotating member, a second rotating member, and a torque transmission portion. The second rotating member is configured to rotate relative to the first rotating member. The torque transmission portion is provided on the first rotating member. The torque transmission portion is configured to transmit torque from one of the first rotating member and the second rotating member to the other of the first rotating member and the second rotating member via a hydraulic fluid.

The torque transmission portion includes an oil chamber portion filled with the hydraulic fluid, a first piston configured to press the second rotating member, a second piston configured to retain the hydraulic fluid in the oil chamber portion with the first piston, and an elastic portion configured to elastically hold the second piston. The first piston receives pressure of the hydraulic fluid on a first pressure receiving area. The second piston receives pressure of the hydraulic fluid on a second pressure receiving area. The first pressure receiving area is smaller than the second pressure receiving area.

In this power transmission device, the rigidity of the power transmission device can be easily reduced by making the first pressure receiving area of the first piston smaller than the second pressure receiving area of the second piston.

Further, the larger the second pressure receiving area of the second piston relative to the first pressure receiving area of the first piston is, the smaller the amount of compression of the elastic portion is. That is, the elastic portion can be reduced in size and weight. The power transmission device for the vehicle can be reduced in size and weight. In addition, since the elastic portion can be reduced in size, the flexibility of the layout of the torque transmission portion can be improved and the hysteresis torque can be reduced.

In the power transmission device for the vehicle according to another aspect of the present invention, the torque transmission portion is preferably provided on the first rotating member so as to rotate integrally with the first rotating member.

In this case, for example, when torque is input to the first rotating member, the torque transmission portion rotates integrally with the first rotating member. That is, the torque is transmitted from the first rotating member to the second rotating member via the hydraulic fluid of the torque transmission portion by the rotation of the first rotating member and the torque transmission portion. When torque is input to the second rotating member, the torque is transmitted from the second rotating member to the first rotating member through a torque transmission path opposite to the above. Even if comprised in this way, the effect similar to the above can be acquired.

In the power transmission device for the vehicle according to another aspect of the present invention, the second piston preferably includes a pressure receiving portion disposed inside the oil chamber portion, and a flange portion protruding from the pressure receiving portion and disposed between the oil chamber portion and the elastic portion.

In this case, since the flange portion of the second piston is disposed between the oil chamber portion and the elastic portion, the second piston can be positioned so that the second piston does not move into the oil chamber portion.

In the power transmission device for the vehicle according to another aspect of the present invention, the first piston is preferably arranged to move in the oil chamber portion in the rotation direction. In this case, the second piston is arranged to move in the oil chamber portion in a direction different from the rotation direction.

With this configuration, the elastic portion that holds the second piston can be arranged in a direction different from the rotation direction. Thereby, the flexibility of the layout of the elastic portion can be improved. That is, the flexibility of the layout of the torque transmission portion can be improved. In addition, since hysteresis torque due to centrifugal force is hardly generated on the elastic portion, the hysteresis torque can be reduced.

In the power transmission device for the vehicle according to another aspect of the present invention, the torque transmission portion preferably further includes a support portion configured to support the elastic portion. In this case, the elastic portion is disposed between the support portion and the second piston.

With this configuration, the elastic portion can be suitably operated. That is, the power transmission device can be suitably operated.

In the power transmission device for the vehicle according to another aspect of the present invention, the first piston is preferably arranged to move in the oil chamber portion in the rotation direction. In this case, the second piston is arranged to move in the oil chamber portion in the rotation direction.

In this configuration, even if the elastic portion that holds the second piston is arranged in the rotational direction, the hysteresis torque can be reduced because the elastic portion is reduced in size as described above.

In the power transmission device for the vehicle according to another aspect of the present invention, the torque transmission portion preferably includes a pair of the oil chamber portions, a pair of the first pistons, a pair of the second pistons, and the elastic portion.

In this case, the pair of the first pistons are arranged respectively in the pair of oil chamber portions. The pair of the first pistons are configured to press the second rotating member. The pair of the second pistons retain respectively the hydraulic fluid in the pair of the oil chamber portions with the pair of the first pistons. The elastic portion is disposed between the pair of second pistons and holds the pair of second pistons.

With this configuration, the elastic portion can be suitably operated. That is, the power transmission device can be suitably operated.

In the present invention, the rigidity of the power transmission device for the vehicle can be easily reduced. Moreover, in this invention, size reduction and weight reduction of the power transmission device for vehicles can be achieved. Further, in this invention, the flexibility of the layout of the torque transmission portion can be improved in the power transmission device. Moreover, in this invention, hysteresis torque can be reduced in the power transmission device for vehicles.

### BRIEF DESCRIPTION OF THE DRAWINGS

FIG. 1 is a cross-sectional view cut along a plane including a rotation shaft in a torque converter having a power transmission device (a first embodiment).

FIG. 2 is a cross-sectional view cut along a plane perpendicular to the rotation axis in the torque converter of FIG. 1 (the first embodiment):

FIG. 3 is a cross-sectional view cut along a plane including a rotation shaft in a torque converter having a power transmission device (a second embodiment).

FIG. 4 is a cross-sectional view cut along a plane perpendicular to the rotation axis in the torque converter of FIG. 2 (the second embodiment).

### DETAILED DESCRIPTION

### First Embodiment

### <Configuration of Power Transmission Device>

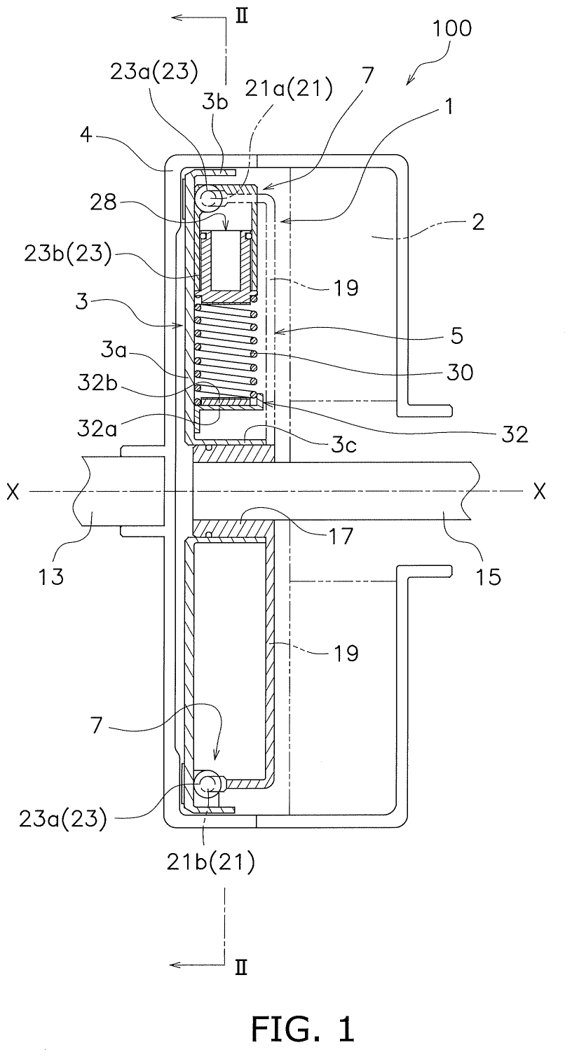

As shown in FIG. 1, the torque converter 100 includes a power transmission device 1 and a torque converter body 2. The torque converter body 2 is connected to the output shaft 15. A front cover 4 is fixed to the torque converter body 2. Since the configuration of the torque converter body 2 is the substantially same as the conventional configuration, the description thereof is omitted here.

As shown in FIG. 1, the power transmission device 1 includes an input rotating member 3 (an example of a first rotation member), an output rotating member 5 (an example of a second rotation member), and at least one torque transmission portion 7. The power transmission device 1 includes a rotation axis X. Hereinafter, a direction along the rotation axis X is described as an axial direction, and a direction away from the rotation axis X is described as a radial direction. A direction around the rotation axis X is described as a rotation direction.

### (Input Rotating Member)

Torque is input to the input rotating member 3. The input rotating member 3 is disposed on an engine side. As shown in FIG. 1, torque from the engine is input to the input rotating member 3 via an input shaft 13. Further, torque fluctuation from the engine is input to the input rotating member 3 via the input shaft 13.

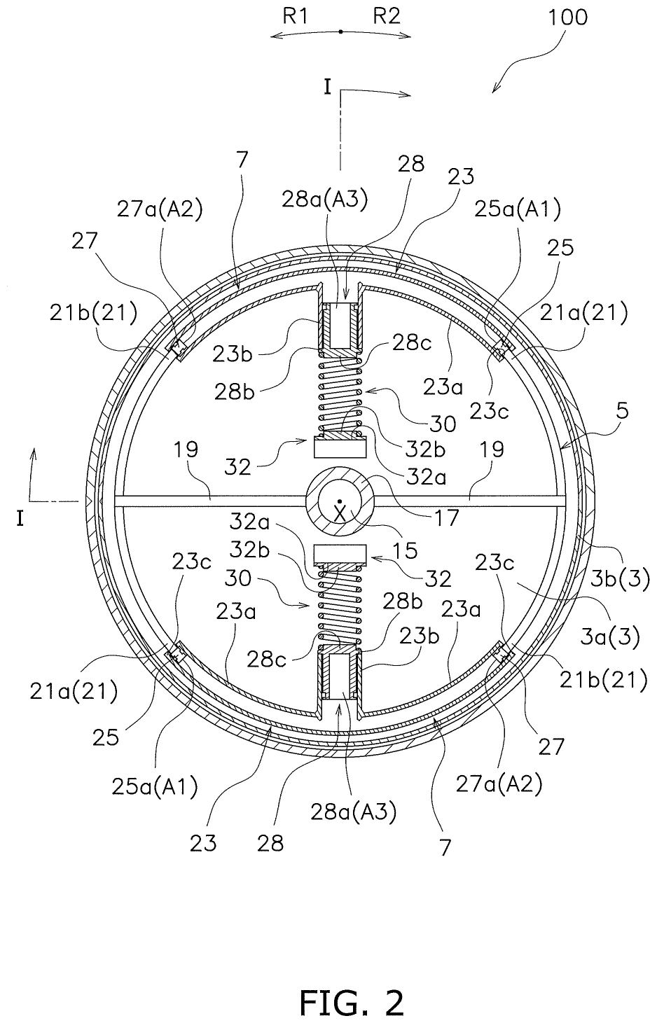

Specifically, as shown in FIGS. 1 and 2, torque from the engine is input to the input rotating member 3 from the front cover 4 to which the input shaft 13 is fixed. A torque fluctuation from the engine is inputted to the input rotating member 3 from the front cover 4 to which the input shaft 13 is fixed.

Specifically, the input rotating member 3 includes a input main body 3a formed in a disc-shape, an outer peripheral annular portion 3b extending from the outer peripheral portion of the input main body 3a in the axial direction, and a first boss portion 3c extending from the inner peripheral portion of the input main body 3a in the axial direction. A friction member 3d is fixed to the input main body 3a. The first boss portion 3c is disposed so as to rotate in the rotational direction and move in the axial direction with respect to the outer peripheral surface of the second boss portion 17 (described later) of the output rotating member 5.

### (Output Rotating Member)

The output rotating member 5 is configured to rotate relative to the input rotating member 3. Specifically, the output rotating member 5 is disposed on the transmission side. Torque is transmitted from the input rotating member 3 to the output rotating member 5 via the torque transmission portion 7. This torque is output from the output rotating member 5 to the output shaft 15.

Specifically, as shown in FIGS. 1 and 2, the output rotating member 5 includes a second boss portion 17, a pair of arm portions 19 extending from the second boss portion 17 in the radial direction, and a pressed portion 21 extending from an end portion (an end portion on the outer peripheral side) each of the arm portions 19 toward the torque transmission portion 7. The output shaft 15 is fixed to the inner peripheral surface of the second boss portion 17. Each of the arm portions 19 connects the second boss portion 17 and the pressed portion 21.

The pressed portion 21 is a portion pressed by the torque transmission portion 7. The pressed portion 21 includes a plurality (for example, two) of first protruding portions 21a and a plurality (for example, two) of second protruding portions 21b.

As shown in FIG. 2, each of the first protruding portion 21a protrudes in circular arc shape from an end portion of each of the arm portions 19 in the first rotation direction R1. The end portion of each of the first protruding portion 21a abuts on a first pressing piston 25 (described later) of the torque transmission portion 7.

Each of the second protruding portions 21b protrudes in an arc shape at the end portion of each of the arm portions 19 in the second rotation direction R2 opposite to the first rotation direction R1. The end portion of each of the second protruding portion 21b abuts on a second pressing piston 27 (described later) of the torque transmission portion 7.

### (Torque Transmission Part)

As shown in FIG. 1, the torque transmission portion 7 is disposed between the input rotating member 3 and the output rotating member 5. The torque transmission portion 7 transmits torque from the input rotating member 3 to the output rotating member 5 by hydraulic fluid.

The torque transmission portion 7 is provided on the input rotating member 3 so as to rotate integrally with the input rotating member 3. In the present embodiment, an example in which at least one torque transmission portion 7 is a plurality (for example, two) of torque transmission portions 7 is illustrated.

Specifically, as shown in FIGS. 1 and 2, each of the torque transmission portions 7 is disposed between the input rotating member 3 and the output rotating member 5 in the axial direction. Each of the torque transmission portions 7 is arranged at the radial inside of the outer peripheral annular portion 3b.

Each of the torque transmission portions 7 includes a cylinder portion 23 (an example of an oil chamber portion), first and second pressing pistons 25, 27 (an example of a first piston), a connecting piston 28 (an example of a second piston), an a coil spring 30 (an example of an elastic portion). Each of the torque transmission portions 7 further includes a support portion 32.

Each of the cylinder portions 23 is a tubular member which is formed in a substantially tubular shape. The internal space of each of the cylinder portions 23 is filled with the hydraulic fluid. Each of the cylinder portions 23 is disposed between the input rotating member 3 and the output rotating member 5 in the axial direction. Each of the cylinder portions 23 is arranged at the radial inner side of the outer peripheral annular portion 3b. Each of the cylinder portions 23 is fixed to the input rotating member 3, for example, the input main body 3a. Each of the cylinder portions 23 is arranged at intervals in the rotation direction.

Each of the cylinder portions 23 includes a first cylinder portion 23a extended in circular arc shape in the rotation direction, and a second cylinder portion 23b extended in the radial inside from the first cylinder portion 23a.

The inner peripheral surface of the first cylinder portion 23a is formed in a circular shape. The first and second pressing pistons 25, 27 are arranged respectively at both ends of the first cylinder portion 23a. A retaining portion 23c for retaining respectively the first and second pressing pistons 25, 27 is provided at both ends of the first cylinder portion 23a. The retaining portion 23c protrudes inward from the both end portions of each of the cylinder portions 23 and is formed in an annular shape.

The inner peripheral surface of the second cylinder portion 23b is formed in a circular shape. The second cylinder portion 23b extends from the first cylinder portion 23a toward the rotation axis X. A connecting piston 28 is disposed at the end portion of the second cylinder portion 23b. The hydraulic fluid is encapsulated in the cylinder portion 23 (the first cylinder portion 23a and the second cylinder portion 23b) by the first and second pressing pistons 25, 27 and the connecting piston 28.

As shown in FIG. 2, the first pressing piston 25 is configured so as to press the output rotating member 5. The first pressing piston 25 is disposed in the cylinder portion 23 so as to move in the rotation direction. Specifically, the first pressing piston 25 is arranged so as to move in each of the first cylinder portion 23a in the rotation direction.

The first pressing piston 25 is arranged in the internal space of each of the first cylinder portions 23a in the one end side of each of the first cylinder portions 23a. The outer peripheral surface of the first pressing piston 25 contacts the inner peripheral surface of each of the first cylinder portions 23a. The first pressing piston 25 is arranged in the internal space of each of the first cylinder portions 23a so as to face the end portion of the first protruding portion 21a.

The first pressing piston 25 includes the first pressure receiving portion 25a which receives the pressure of the hydraulic fluid. The first pressure receiving portion 25a is substantially formed in a cylindrical shape. The outer peripheral surface of the first pressure receiving portion 25a contacts with the inner peripheral surface of each of the first cylinder portions 23a. A space between the first pressure receiving portion 25a and each of the first cylinder portions 23a is sealed by a sealing member such as an O-ring. The first pressure receiving portion 25a includes a first pressure receiving area A1. In the present embodiment, the first pressure receiving area A1 is the substantially same as an area calculated based on the inner diameter of each of the first cylinder portion 23a.

The first pressing piston 25 is configured to abut to the end portion of the first protruding portion 21a. Torque is transmitted from the input rotating member 3 to the output rotating member 5 when the first pressing piston 25 presses the first protruding portion 21a. The first pressing piston 25 is prevented from being detached from each of the first cylinder portions 23a by the retaining portion 23c.

As shown in FIG. 2, the second pressing piston 27 is configured to press the output rotating member 5. The second pressing piston 27 is disposed in the cylinder portion 23 so as to move in the rotation direction. In detail, the second pressing piston 27 is arranged so as to move in each of the first cylinder portions 23a in the rotation direction.

The second pressing piston 27 is arranged in the internal space of each of the cylinder portions 23 in the other end side of each of the first cylinder portions 23a. The outer peripheral surface of the second pressing piston 27 contacts with the internal peripheral surface of each of the first cylinder portions 23a. The second pressing piston 27 is arranged in the internal space of each of the first cylinder portions 23a so as to oppose the end portion of the second protruding portion 21b.

The second pressing piston 27 includes the second pressure receiving portion 27a which receives the pressure of the hydraulic fluid. The second pressure receiving portion 27a is substantially formed in a cylindrical shape. The outer peripheral surface of the second pressure receiving portion 27a contact with the inner peripheral surface of each of the first cylinder portions 23a. A space between the second pressure receiving portion 27a and each of the first cylinder portions 23a is sealed by a sealing member such as an O-ring. The second pressure receiving portion 27a includes a second pressure receiving area A2. In the present embodiment, the second pressure receiving area A2 is the substantially same as an area calculated based on the inner diameter of each of the first cylinder portions 23a. The second pressure receiving area A2 is the same as the first pressure receiving area A1.

In the present embodiment, an example in which the first pressure receiving area A1 and the second pressure receiving area A2 are the same is illustrated, but the first pressure receiving area A1 and the second pressure receiving area A2 can be different. The first pressure receiving area A1 and the second pressure receiving area A2 are examples of “first pressure receiving area in claims”.

The second pressing piston 27 is configured to abut to the end portion of the second protruding portion 21b. Torque is transmitted from the input rotating member 3 to the output rotating member 5 when the second pressing piston 27 presses the second protruding portion 21b. The second pressing piston 27 is prevented from being detached from each of the first cylinder portions 23a by the retaining portion 23c.

The connecting piston 28 retains the hydraulic fluid in the cylinder portion 23 in cooperation with the first and second pressing pistons 25, 27. As shown in FIGS. 1 and 2, the connecting piston 28 is arranged in each of the cylinder portions 23 so as to move in the direction different from the rotation direction. In the present embodiment, the connecting piston 28 is disposed so as to move in each of the cylinder portions 23 in the radial direction.

As shown in FIG. 2, the connecting piston 28 is disposed in the internal space of each of the second cylinder portions 23b on the tip side of each of the second cylinder portions 23b. The connecting piston 28 is disposed in the internal space of each of the second cylinder portions 23b so as to contact the inner peripheral surface of each of the second cylinder portions 23b and to face the coil spring 30.

The connecting piston 28 includes a third pressure receiving portion 28a, a flange portion 28b, and a first engaging portion 28c. The third pressure receiving portion 28a is a portion that receives the pressure of the hydraulic fluid. The third pressure receiving portion 28a is disposed in the internal space of each of the second cylinder portions 23b. The third pressure receiving portion 28a is substantially formed in a cylindrical shape. The outer peripheral surface of the third pressure receiving portion 28a contacts with the inner peripheral surface of each of the second cylinder portions 23b. A space between the third pressure receiving portion 28a and each of the second cylinder portions 23b is sealed by a sealing member such as an O-ring.

The third pressure receiving portion 28a includes a third pressure receiving area A3. In the present embodiment, the third pressure receiving area A3 is the substantially same as the area calculated based on the inner diameter of each of the second cylinder portions 23b. The third pressure receiving area A3 is larger than the first pressure receiving area A1 and the second pressure receiving area A2. In other words, the first and second pressure receiving areas A1, A2 are smaller than the third pressure receiving area A3. The third pressure receiving area A3 is an example of “second pressure receiving area in claims”.

The flange portion 28b protrudes in an annular shape from the outer peripheral surface of the third pressure receiving portion 28a. The flange portion 28b is disposed between each of the second cylinder portions 23b and the coil spring 30. For example, the flange portion 28b is configured to contact with the end portion of each of the second cylinder portions 23b and to be separated from the end portion of each of the second cylinder portions 23b. In a state where the flange portion 28b contacts with the end portion of each of the second cylinder portions 23b, the first and second pressing pistons 25, 27 contact with the retaining portion 23c.

The first engaging portion 28c engages with the inner peripheral portion of the coil spring 30. The first engaging portion 28c protrudes from the third pressure receiving portion 28a toward the coil spring 30. The first engaging portion 28c is disposed in the inner peripheral portion of the coil spring 30.

As shown in FIGS. 1 and 2, the coil spring 30 elastically holds the connecting piston 28. The coil spring 30 is disposed between the connecting piston 28 and the support portion 32. Specifically, the coil spring 30 elastically holds the connecting piston 28 while being supported by the support portion 32.

For example, the coil spring 30 is disposed between the connecting piston 28 and the support portion 32 in a compressed state. In this state, when the connecting piston 28 moves along the second cylinder portion 23b, the coil spring 30 expands and contracts.

As shown in FIGS. 1 and 2, the support portion 32 supports the coil spring 30. The support portion 32 is provided on the input rotating member 3. Specifically, as shown in FIG. 1, the support portion 32 is disposed between the input main body 3a of the input rotating member 3 and the output rotating member 5 in the axial direction. The support portion 32 is provided so as to rotate integrally with the input main body 3a.

Specifically, the support portion 32 includes a support body 32a and a second engaging portion 32b. The support body 32a is fixed to the input main body 3a and extends in the axial direction. The second engaging portion 32b protrudes radially outward from the support body 32a. The second engaging portion 32b engages with the inner peripheral portion of the coil spring 30.

### <Operation of Power Transmission Device>

The power transmission device 1 including the above configuration operates as follows. In a state where the torque from the engine is input to the front cover 4 of the torque converter 100 via the input shaft 13, when the friction member 3d contacts with the front cover, the power transmission device starts operating. That is, the power transmission device 1 operates in the lock-up state. On the other hand, when the friction member 3d is separated from the front cover, the power transmission device 1 does not operate and the torque converter body 2 operates.

When the input rotating member 3 rotates in the lock-up state, the torque transmission portion 7 rotates with the input rotating member 3. In this state, when the input rotating member 3 and the torque transmission portion 7 rotate in the first rotation direction R1 or the second rotation direction R2, the torque transmission portion 7 presses the output rotating member 5. Thereby, torque is transmitted from the input rotating member 3 to the output rotating member 5 via the torque transmission portion 7.

Specifically, when the input rotating member 3 and the torque transmission portion 7 rotates in the second rotation direction R2, the first pressing piston 25 of the torque transmission portion 7 abuts to the pressed portion 21 of the output rotating member 5, for example, the end portion of the first protruding portion 21a. In this state, the first pressing piston 25 presses the end portion of the first protruding portion 21a.

Then, the first pressing piston 25 moves inside the first cylinder portion 23a in the first rotation direction R1.

Thereby, the connecting piston 28 moves radially inward along the second cylinder portion 23b via the hydraulic fluid. In this state, the second pressing piston 27 contacts with the retaining portion 23c.

Here, since the third pressure receiving area A3 is larger than the first pressure receiving area A1, the force of the oil acting on the connecting piston 28 is smaller than the force of the oil acting on the first pressing piston 25. Further, the stroke amount S3 of the connecting piston 28 is smaller than the stroke amount S1 of the first pressing piston 25.

For example, the stroke amount S3 of the connecting piston 28 is determined by the ratio (A1/A3) of the first pressure receiving area A1 to the third pressure receiving area A3. For example, the stroke amount S3 of the connecting piston 28 is obtained by the equation “S3=S1×(A1/A3)”.

When the connecting piston 28 moves in this way, the coil spring 30 holds the connecting piston 28 in a compressed state. In this state, the end portion of the second protruding portion 21b is separated from the second pressing piston 27. The torque is transmitted from the input rotating member 3 to the output rotating member 5 by operating the torque transmission portion 7 in this manner.

On the other hand, when the input rotating member 3 and the torque transmission portion 7 rotates in the first rotation direction R1, the second pressing piston 27 of the torque transmission portion 7 abuts to the pressed portion 21 of the output rotating member 5, for example, the end portion of the second protruding portion 21b. In this state, the second pressing piston 27 presses the end portion of the second protruding portion 21b.

Then, the second pressing piston 27 moves inside the first cylinder portion 23a in the second rotation direction R2. Thereby, the connecting piston 28 moves radially inward along the second cylinder portion 23b via the hydraulic fluid. In this state, the first pressing piston 25 contacts with the retaining portion 23c.

Here, since the third pressure receiving area A3 is larger than the second pressure receiving area A2, the force of the oil acting on the connecting piston 28 is smaller than the force of the oil acting on the second pressing piston 27. Further, the stroke amount S3 of the connecting piston 28 is smaller than the stroke amount S2 of the second pressing piston 27.

For example, the stroke amount S3 of the connecting piston 28 is determined by the ratio (A2/A3) of the second pressure receiving area A2 to the third pressure receiving area A3. For example, the stroke amount S3 of the connecting piston 28 is obtained by the equation “S3=S2×(A2/A3)”.

When the connecting piston 28 moves in this way, the coil spring 30 holds the connecting piston 28 in a compressed state. In this state, the end portion of the first protruding portion 21a is separated from the first pressing piston 25. The torque is transmitted from the input rotating member 3 to the output rotating member 5 by operating the torque transmission portion 7 in this manner.

In the power transmission device 1 operating in this way, the first pressure receiving area A1 of the first pressing piston 25 and the second pressure receiving area A2 of the second pressing piston 27 is smaller than the third pressure receiving area A3 of the connecting piston 28. As a result, the rigidity of the power transmission device 1 can be easily reduced.

Further, as the third pressure receiving area A3 of the connecting piston 28 with respect to the first pressure receiving area A1 of the first pressing piston 25 is increased, the amount of compression of the coil spring 30 can be reduced. Further, as the third pressure receiving area A3 of the connecting piston 28 with respect to the second pressure receiving area A2 of the second pressing piston 27 is increased, the amount of compression of the coil spring 30 can be reduced.

Thereby, size reduction and weight reduction of the coil spring 30 can be achieved. That is, the power transmission device 1 can be reduced in size and weight. Further, by reducing the size of the coil spring 30, the flexibility of the layout of the torque transmission portion 7 can be improved, and the hysteresis torque can be reduced.

### Second Embodiment

The configuration of the torque converter 200 of the second embodiment is the substantially same as the configuration of the first embodiment except for the torque transmission portion 107. Further, the configuration of the torque transmission portion 107 of the second embodiment partially includes the same configuration as the torque transmission portion 7 of the first embodiment. For this reason, in the second Embodiment, description is omitted about the same structure as first Embodiment. The description omitted here is based on the description of the first embodiment.

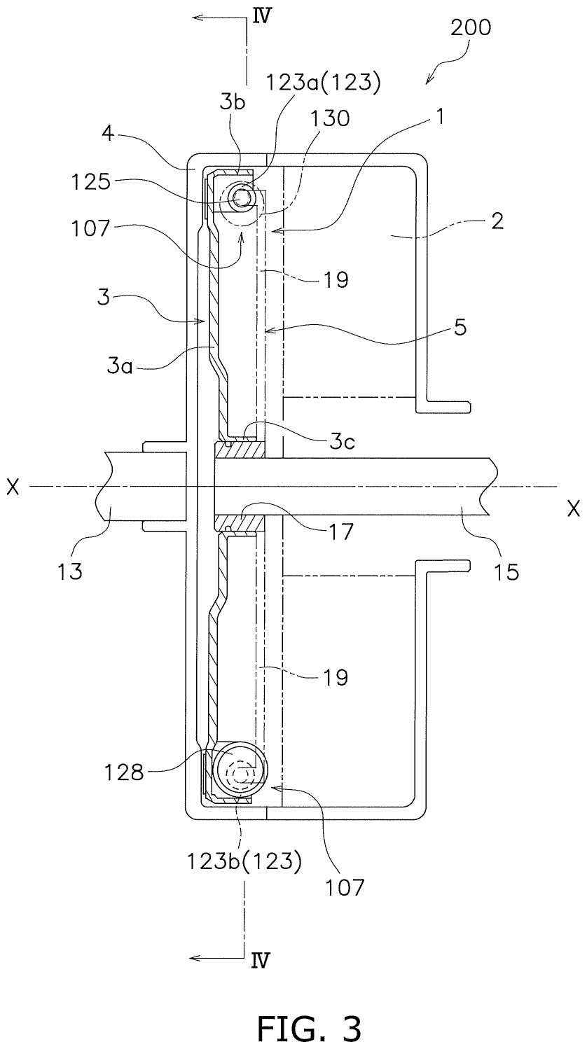

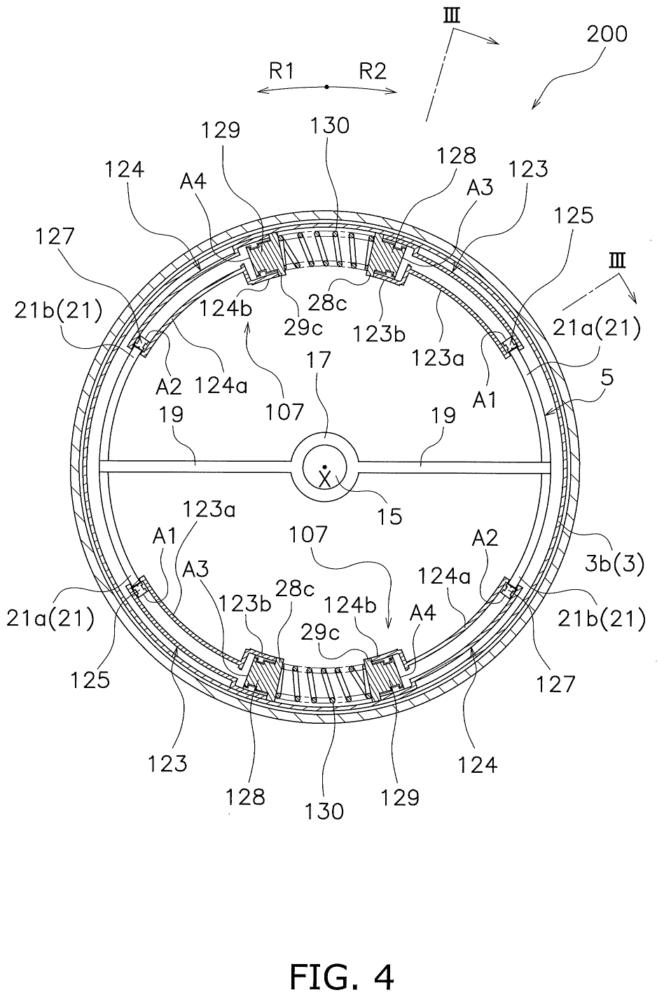

As shown in FIGS. 3 and 4, the torque transmission portion 107 is disposed between the input rotating member 3 and the output rotating member 5. The torque transmission portion 107 transmits torque from the input rotating member 3 to the output rotating member 5 via the hydraulic fluid. The torque transmission portion 107 is provided on the input rotating member 3 so as to rotate integrally with the input rotating member 3. In the present embodiment, an example in which at least one torque transmission portion 107 is a plurality of (for example, two) torque transmission portions 107 is illustrated.

Specifically, each of the torque transmission portions 107 is disposed between the input rotating member 3 and the output rotating member 5 in the axial direction. Each of the torque transmission portions 107 is disposed on the radially inner side of the outer peripheral annular portion 3b.

Each of the torque transmission portions 107 includes third and fourth cylinder portions 123, 124 (an example of a pair of oil chamber portions), first and second pressing pistons 125, 127 (an example of a pair of first pistons), and first and second connecting pistons 128, 129 (an example of a pair of second pistons) and a coil spring 130 (an example of an elastic portion).

Each of the third and fourth cylinder portions 123, 124 is a tubular member formed in a substantially tubular shape. The internal spaces of the third and fourth cylinder portions 123, 124 are filled with the hydraulic fluid.

The third and fourth cylinder portions 123, 124 are disposed between the input rotating member 3 and the output rotating member 5 in the axial direction. The third and fourth cylinder portions 123, 124 are spaced apart from each other in the rotational direction. The third and fourth cylinder portions 123, 124 are disposed on the radially inner side of the outer peripheral annular portion 3b. The third and fourth cylinder portions 123, 124 are fixed to input rotating member 3, for example, the input main body 3a.

As shown in FIG. 4 the third cylinder portion 123 includes a first small-diameter cylinder portion 123a and a first large-diameter cylinder portion 123b. The first small-diameter cylinder portion 123a extends in an arc shape in the rotation direction. For example, the inner peripheral surface of the first small-diameter cylinder portion 123a is formed in a circular shape. The first pressing piston 125 is arranged at the end portion of the first small-diameter cylinder portion 123a.

The first large-diameter cylinder portion 123b is connected to the first small-diameter cylinder portion 123a and extends from the first small-diameter cylinder portion 123a in an arc shape in the rotation direction. For example, the inner peripheral surface of the first large-diameter cylinder portion 123b is formed in a circular shape. The inner diameter of the first large-diameter cylinder portion 123b is larger than the inner diameter of the first small-diameter cylinder portion 123a. The first connecting piston 128 is arranged at the end portion of the first large-diameter cylinder portion 123b.

The fourth cylinder portion 124 includes a second small-diameter cylinder portion 124a and a second large-diameter cylinder portion 124b. The second pressing piston 127 is arranged at the end portion of the second small-diameter cylinder portion 124a. A second connecting piston 129 is disposed at the end portion of the second large-diameter cylinder portion 124b.

Except for this point, since the configurations of the second small-diameter cylinder portion 124a and the second large-diameter cylinder portion 124b are the same as the configurations of the first small-diameter cylinder portion 123a and the first large-diameter cylinder portion 123b. The description thereof is omitted.

The first pressing piston 125 is arranged in the internal space of the first small-diameter cylinder portion 123a. The first pressing piston 125 includes the first pressure receiving area A1 as well as the first embodiment. The second pressing piston 127 is disposed in the internal space of the second small-diameter cylinder portion 124a. The second pressing piston 127 includes the second pressure receiving area A2 as well as the first embodiment. The second pressure receiving area A2 is the same as the first pressure receiving area A1. The first pressure receiving area A1 and the second pressure receiving area A2 are examples of“first pressure receiving area in claims”.

The relationship between the first and second pressing pistons 125, 127 and the first and second small-diameter cylinder portions 123a, 124a is the same as that of the first and second pressing pistons 25, 27 and the first cylinder portion 23a in the first embodiment. Therefore, the description thereof is omitted here.

The first connecting piston 128 is disposed in the internal space of the first large-diameter cylinder portion 123b. The first connecting piston 128 is arranged so as to move in the first large-diameter cylinder portion 123b in the rotation direction. The first connecting piston 128 includes a third pressure receiving area A3 as well as the first embodiment. The configuration of the first connecting piston 128 is the substantially same as the configuration of the connecting piston 28 of the first embodiment.

The second connecting piston 129 is disposed in the internal space of the second large-diameter cylinder portion 124b. The second connecting piston 129 is disposed so as to move in the second large-diameter cylinder portion 124b in the rotational direction. The second connecting piston 129 includes a fourth pressure receiving area A4. The fourth pressure receiving area A4 is the same as the third pressure receiving area A3. The configuration of the second connecting piston 129 is the substantially same as that of the first connecting piston 128.

In the present embodiment, an example in which the third pressure receiving area A3 and the fourth pressure receiving area A4 are the same is illustrated, but the third pressure receiving area A3 and the fourth pressure receiving area A4 can be different. The third pressure receiving area A3 and the fourth pressure receiving area A4 are examples of “second pressure receiving area in claims”.

The relationship between the first and second connecting pistons 128, 129 and the first and second large-diameter cylinder portions 123b, 124b is the same as the relationship between the connecting piston 28 and the second cylinder portion 23b in the first embodiment. Therefore, explanation is omitted here.

The coil spring 130 is disposed between the first connecting piston 128 and the second connecting piston 129. Specifically, the coil spring 130 is disposed between the first connecting piston 128 and the second connecting piston 129 in the rotational direction.

The coil spring 130 elastically holds the first connecting piston 128 while being supported by the second connecting piston 129. The coil spring 130 elastically holds the second connecting piston 129 while being supported by the first connecting piston 128.

Since the engagement relationship between the coil spring 130 and the first and second connecting piston 128, 129 is the same as that in the first embodiment, the description thereof is omitted here.

### <Operation of Power Transmission Device>

The power transmission device 1 including the above configuration operates as follows. When the input rotating member 3 and the torque transmission portion 107 rotate in the second rotation direction R2, the first pressing piston 125 of the torque transmission portion 107 abuts to the pressed portion 21 of the output rotating member 5, for example, the end portion of the first protruding portion 21a. In this state, the first pressing piston 25 presses the end portion of the first protruding portion 21a.

Then, the first pressing piston 125 moves inside the first small-diameter cylinder portion 123a in the first rotation direction R1. Thereby, the first connecting piston 128 moves along the first large-diameter cylinder portion 123b in the first rotation direction R1 via the hydraulic fluid.

In this case, the second pressing piston 127 contacts with the retaining portion 23c provided at the end portion of the second small-diameter cylinder portion 124a. The flange portion 28b of the second connecting piston 129 contacts with the end portion of the second large-diameter cylinder portion 124b. The configuration of this flange portion 28b is the same as the configuration of the above flange portion 28b.

Here, since the third pressure receiving area A3 is larger than the first pressure receiving area A1, the force acting of the oil on the first connecting piston 128 is smaller than the force of the oil acting on the first pressing piston 125. Further, the stroke amount S3 of the first connecting piston 128 is smaller than the stroke amount S1 of the first pressing piston 125.

For example, the stroke amount S3 of the first connecting piston 128 is determined by the ratio (A1/A3) of the first pressure receiving area A1 to the third pressure receiving area A3. For example, the stroke amount S3 of the first connecting piston 128 is obtained by the equation “S3=S1×(A1/A3)”.

When the first connecting piston 128 moves in this way, the coil spring 130 holds the first connecting piston 128 in a compressed state. In this state, the end portion of the second protruding portion 21b is separated from the second pressing piston 127. By operating the torque transmission portion 107 in this way, torque is transmitted from the input rotating member 3 to the output rotating member 5.

On the other hand, when the input rotating member 3 and the torque transmission portion 7 are rotated in the first rotation direction R1, the second pressing piston 127 of the torque transmission portion 107 abuts to the pressed portion 21 of the output rotating member 5, for example, the end portion of the second protruding portion 21b. In this state, the second pressing piston 127 presses the end portion of the second protruding portion 21b.

Then, the second pressing piston 127 moves inside the second small-diameter cylinder portion 124a in the second rotation direction R2. Thereby, the second connecting piston 129 moves along the second large-diameter cylinder portion 124b in the second rotation direction R2 via the hydraulic fluid.

In this case, the first pressing piston 125 abuts to the retaining portion 23c provided in the end portion of the first small-diameter cylinder portion 123a. The flange portion 28b of the first connecting piston 128 contacts with the end portion of the first large-diameter cylinder portion 123b.

Here, since the fourth pressure receiving area A4 is larger than the second pressure receiving area A2, the force acting of the oil on the second connecting piston 129 is smaller than the force of the oil acting on the second pressing piston 127. Further, the stroke amount S4 of the second connecting piston 129 is smaller than the stroke amount S2 of the second pressing piston 127.

For example, the stroke amount S4 of the second connecting piston 129 is determined by the ratio (A2/A4) of the second pressure receiving area A2 to the fourth pressure receiving area A4. For example, the stroke amount S4 of the second connecting piston 129 is obtained by the equation “S4=S2×(A2/A4)”.

When the second connecting piston 129 moves in this way, the coil spring 130 holds the second connecting piston 129 in a compressed state. In this state, the end portion of the first protruding portion 21a is separated from the first pressing piston 125. By operating the torque transmission portion 107 in this way, torque is transmitted from the input rotating member 3 to the output rotating member 5.

In the power transmission device 1 that operates as described above, the first pressure receiving area A1 of the first pressing piston 125 and the second pressure receiving area A2 of the second pressing piston 127 is smaller than the third pressure receiving area A3 of the first connecting piston 128 and the fourth pressure receiving area A4 of the second connecting piston 129. Thereby, the rigidity of the power transmission device 1 can be easily reduced.

Further, as the third and fourth pressure receiving areas A3, A4 with respect to the first and second pressure receiving areas A1. A2 are increased, the amount of compression of the coil spring 130 can be reduced. Thereby, size reduction and weight reduction of the coil spring 130 can be achieved. That is, the power transmission device 1 can be reduced in size and weight. Further, by reducing the size of the coil spring 130, the flexibility of freedom of the layout of the torque transmission portion 7 can be improved, and the hysteresis torque can be reduced.

### Other Embodiments

The present invention is not limited to the above embodiments, and various changes or modifications can be made without departing from the scope of the present invention.

(A) In the first and second embodiments, the example in case the power transmission device 1 is applied to the torque converters 100 and 200 was used. If the power transmission device 1 is on the power transmission path of the vehicle, the present invention can be applied to other configurations.

(B) If each of components of the power transmission device 1 shown in the first and second embodiments transmits torque from the input rotating member 3 to the output rotating member 5 by the pressure of the hydraulic fluid in the torque transmission portions 7, 107, each of components of the power transmission device 1 can include any configuration.

(C) In the first and second embodiments, in case of assuming that the hydraulic fluid leaks from the cylinder portion 23, the one-way valve that guides the hydraulic fluid in the torque converters 100, 200 to the cylinder portion 23 can be provided in the cylinder portion 23. Further, this one-way valve can be provided in the third cylinder portion 123 and the fourth cylinder portion 124.

(D) In the first embodiment, the example in which the connecting piston 28 moves in the radial direction is illustrated. However, if moving direction of the connecting piston 28 is different from the rotational direction, the moving direction of the connecting piston 28 can set the other direction.

(E) In the first embodiment, the example in case the second cylinder portion 23b extended in the radial direction was illustrated. If direction where the second cylinder portion 23b extends is a direction different from the rotation direction, the direction can set the other direction.

(F) In the first embodiment, an example in which there is one second cylinder portion 23b is illustrated, but a plurality of second cylinder portions 23b can be provided in the first cylinder portion 23a.

In this case, each of the torque transmission portions 7 is arranged such that the total pressure receiving area A3 of the plurality of connecting pistons 28 arranged respectively in the plurality of second cylinder portions 23b is larger than the first pressure receiving area A1 and the second pressure receiving area A2.

In this case, if the total pressure receiving area A3 is larger than the first pressure receiving area A1 and the second pressure receiving area A2, the pressure receiving area A3 of each of the third pressure receiving portions 28a of the plurality of connecting pistons 28 can be smaller than the first pressure receiving area A1 and/or the second pressure receiving area A2.

(G) In the first and second embodiments, an example in which the power transmission device 1 is arranged on the power transmission path of the vehicle with the input rotating member 3 as the input side rotation member and the output rotating member 5 as the output side rotation member, is illustrated. Instead of this, the output rotating member 5 (an example of a first rotating member) can be an input-side rotating member, and the input rotating member 3 (an example of a second rotating member) may be an output-side rotating member in on the power transmission path of the vehicle.

### REFERENCE SIGNS LIST

100,200 Torque converter
1 Power transmission device
3 Input rotation member
5 Output rotating member
7,107 Torque transmission portion
9 Hydraulic control portion
23 Cylinder portion
23a First cylinder portion
23b Second cylinder portion
23c Retaining portion
25,125 First pressing piston
27, 127 Second pressing piston
28 Connection piston
28a Third pressure receiving portion
28b, 29b flange portion
30,130 Coil spring
123 Third cylinder
123a First small-diameter cylinder
123b First large-diameter cylinder
124 fourth cylinder portion
124a second small-diameter cylinder portion
124b Second large-diameter cylinder portion
125 First pressing piston
127 Second pressing piston
128 First connecting piston
129 Second connecting piston
A1, A2 first and second pressure receiving areas
A3, A4 third and fourth pressure receiving area

What is claimed is:

1. A power transmission device for a vehicle comprising:
a first rotating member;
a second rotating member configured to rotate relative to the first rotating member; and
a torque transmission portion provided on the first rotating member and configured to transmit torque from one of the first rotating member and the second rotating member to the other of the first rotating member and the second rotating member via a hydraulic fluid,
the torque transmission portion including an oil chamber portion filled with the hydraulic fluid, a first piston configured to press the second rotating member, a second piston configured to retain the hydraulic fluid in the oil chamber portion with the first piston, and an elastic portion configured to elastically hold the second piston, and
the first piston further configured to receive pressure of the hydraulic fluid on a first pressure receiving area, and the second piston further configured to receive pressure of the hydraulic fluid on a second pressure receiving area, with the first pressure receiving area being smaller than the second pressure receiving area.

2. The power transmission device for the vehicle according to claim 1, wherein
the torque transmission portion is provided on the first rotating member so as to rotate integrally with the first rotating member.

3. The power transmission device for the vehicle according to claim 1, wherein
the second piston includes a pressure receiving portion disposed inside the oil chamber portion, and a flange portion protruding from the pressure receiving portion and disposed between the oil chamber portion and the elastic portion.

4. The power transmission device for the vehicle according to claim 1, wherein
the first piston is arranged to move in the oil chamber portion in a rotation direction, and
the second piston is arranged to move in the oil chamber portion in a direction different from the rotation direction.

5. The power transmission device for the vehicle according to claim 4, wherein
the torque transmission portion further includes a support portion configured to support the elastic portion, and
the elastic portion is disposed between the support portion and the second piston.

6. The power transmission device for the vehicle according to claim 1, wherein
the first piston is arranged to move in the oil chamber portion in a rotation direction,
the second piston is arranged to move in the oil chamber portion in the rotation direction.

7. The power transmission device for the vehicle according to claim 6, wherein
the oil chamber portion includes a pair of oil chamber portions,
the first piston includes a pair of first pistons arranged respectively in the pair of oil chamber portions and configured to press the second rotating member,
the second piston includes a pair of second pistons configured to retain respectively the hydraulic fluid in the pair of oil chamber portions, and
the elastic portion is disposed between the pair of second pistons and configured to hold the pair of second pistons.
